(19) United States
(12) Patent Application Publication
(10) Pub. No.: US 2013/0100670 A1
(43) Pub. Date: Apr. 25, 2013

(54) LIGHTING SYSTEM WITH A HEAT SINK HAVING PLURALITY OF HEAT CONDUITS

(71) Applicants: Thomas D. Dreeben, Swampscott, MA (US); James A. Gotay, Lowell, MA (US); Kenneth G. Grossman, Beverly, MA (US)

(72) Inventors: Thomas D. Dreeben, Swampscott, MA (US); James A. Gotay, Lowell, MA (US); Kenneth G. Grossman, Beverly, MA (US)

(73) Assignee: OSRAM SYLVANIA INC., Danvers, MA (US)

(21) Appl. No.: 13/277,500

(22) Filed: Oct. 20, 2011

(51) Int. Cl. F21V 29/00; F21V 21/00

(52) U.S. Cl. 362/249.02; 362/249.01

(57) ABSTRACT

A lighting system includes a heat sink having an upper and a lower face, and a plurality of light engines. The heat sink includes a plurality of individual, enclosed heat conduits extending generally parallel to a longitudinal axis of the heat sink between the upper and the lower faces. Each heat conduit has an entrance proximate to the lower face and an exit proximate to the upper face. The light engines are each coupled to at least one heat conduit such that thermal energy generated by the light engines is transferred to the heat conduits to cause air to flow through each of the heat conduits due to convection.

### TECHNICAL FIELD

The present disclosure relates to luminaires, and more particularly pertains to luminaires and methods for reducing the junction temperature of a LED-based light engines.

### BACKGROUND

Light emitting diodes (LEDs) provide numerous advantages including, but not limited to, low power consumption, low heat production, and long life. While LEDs produce less heat compared to other types of lights (e.g., high-intensity discharge (HID) bulbs, incandescent light bulbs, and the like), LEDs nevertheless generate thermal energy which should be managed in order to control the junction temperature. A higher junction temperature generally correlates to lower light output, lower luminaire efficiency, and/or reduced life expectancy. Managing thermal energy is particularly important as the number of LEDs in the light is increased, and even more so as the light capacity (e.g., the number of LEDs per area) of the light increases. In particular, when LEDs are surrounded by other LEDs, the thermal energy generated by adjacent LEDs may significantly increase the junction temperature of the LEDs.

### SUMMARY

One embodiment of the present disclosure addresses these problems (e.g., cumulative effect of heat from adjacent LEDs) by providing a heat sink having a plurality of enclosed, individual heat conduits that are open at opposed ends, wherein each LED is associated with a heat conduit. The heat conduits transfer thermal energy to the air and generate air flow (due to natural convection) through the heat sink heat. As such, each LED is provided with a heat path to ambient air which is sufficiently direct that is reduces and/or eliminates any heat generated by adjacent LEDs.

### BRIEF DESCRIPTION OF THE DRAWINGS

As used herein, a plurality of like components is generally referred to collectively using a reference numeral followed by the designation “(1)-(n)”, where “n” is an integer greater than one. Any one of the plurality of components is generally referred to using the reference numeral only.

Features and advantages of the claimed subject matter will be apparent from the following description of embodiments consistent therewith, which description should be considered in conjunction with the accompanying drawings, wherein:

FIG. 1 is an illustration of one exemplary embodiment of a lighting system consistent with the present disclosure;

FIG. 2 is a bottom end view of one embodiment of a lighting system consistent with the present disclosure;

FIG. 3 is a partial perspective view of the lighting system of FIG. 2 showing in particular the structure of the heat sink;

FIG. 4 is a close-up of region C of the lighting system of FIG. 2;

FIG. 5a is a bottom end perspective view of yet another embodiment of a lighting system consistent with the present disclosure;

FIG. 5b is a bottom end perspective view of another embodiment of the lighting system of FIG. 5a consistent with the present disclosure;

FIG. 6a is a bottom end perspective view of a further embodiment of a lighting system consistent with the present disclosure;

FIG. 6b is a bottom end perspective view of another embodiment of the lighting system of FIG. 6a consistent with the present disclosure;

FIG. 7 is a bottom end view of yet another embodiment of a lighting system consistent with the present disclosure;

FIG. 8 is a bottom end view of yet a further embodiment of a lighting system consistent with the present disclosure; and

FIG. 9 is a temperature map of a simulated air flow within a heat conduit consistent with the present disclosure.

### DETAILED DESCRIPTION OF THE INVENTION

By way of a brief overview, one embodiment of the present disclosure is directed towards a lighting system having increased thermal management capabilities. For example, a lighting system consistent with at least one embodiment may include a heat sink defining a plurality of enclosed, individual heat conduits having at least one sidewall. Each heat conduit is open at opposed ends and extends between an entrance at a lower face and an exit at an upper face. A plurality of light engines may be mounted to the heat sink. A portion of thermal energy generated by the light engines may be transferred to the sidewalls of at least two adjacent heat conduits. The heat conduits then transfer a portion of the thermal energy to the air around the heat sink, causing the temperature of the air to increase. Natural convection causes air to flow through the heat conduits of the heat sink. Because each light engine is provided with a sufficiently direct heat path to ambient air, the cumulative effects of the thermal energy generated by adjacent light engines is reduced and/or eliminated. As a result, the junction temperature of the light engines may be reduced (particularly for light engines which are surrounded by one or more adjacent light engines), and the light capacity (i.e., the number of light engines per cross-sectional area of the lighting system) may be increased. Accordingly, the lifespan of the light engines may be increased (e.g., due to the reduced junction temperature at steady state) and/or the luminous power (i.e., luminous flux) of the lighting system may be greatly increased. While the lighting system as described herein may be particularly well suited for high-bay applications, this is not a limitation of the present disclosure unless specifically claimed as such.

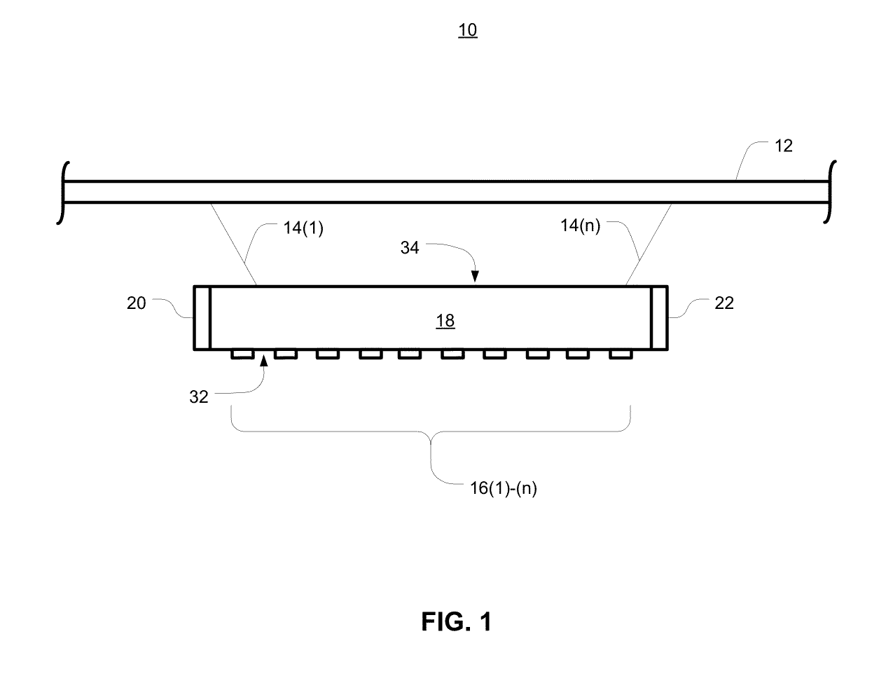

Turning now to FIG. 1, a lighting system 10 consistent with at least one embodiment of the present disclosure is generally illustrated. The lighting system 10 may be coupled, mounted, suspended, or otherwise secured to a support surface 12, for example, a ceiling. According to one embodiment, the lighting system 10 may provide lighting in a high-bay application, i.e., the lighting system 10 may be suspended from the ceiling 12, for example, using one or more wires, cables, rods or the like 14(1)-(n). It may be appreciated, however, that the lighting system 10 may also be secured directly to the ceiling 12 (or portion thereof, such as a ceiling support/rafter or the like). An example of securing the lighting system 10 directly to the ceiling 12 includes flush mounting, provided that air may flow through the lighting system 10.

The lighting system 10 includes a plurality of light engines 16(1)-(n) which may be mounted, coupled, or otherwise secured to a heat sink 18 (e.g., proximate to the lower face 32 of the heat sink 18). Thermal energy generated by the light engines 16(1)-(n) is transferred to the heat sink 18 by way of a plurality of individual, enclosed heat conduits extending through the heat sink 18. As described herein, the thermal energy is then transmitted from the heat conduits, which causes air to flow through the heat conduits (e.g., from the lower face 32 to the upper face 34 of the heat sink 18).

One or more of the light engines 16(1)-(n) may include one or more light emitting diodes (LEDs). The LEDs may be coupled to a printed circuit board (PCB) (not shown for clarity), and may include any semiconductor light source such as, but not limited to, conventional high-brightness semiconductor LEDs, organic light emitting diodes (OLEDs), bi-color LEDs, tri-color LEDs, polymer light-emitting diodes (PLED), electro-luminescent strips (EL), etc. The LEDs may include, but are not limited to, packaged and non-packaged LEDs, chip-on-board LEDs, as well as surface mount LEDs. The LEDs may also include LEDs with phosphor or the like for converting energy emitted from the LED to a different wavelength of light. The light engines 16(1)-(n) may be simultaneously and/or independently controlled, for example, to adjust the overall color emitted from the lighting system 10 and/or compensate for changes in the output of the light engines 16(1)-(n), for example, due to age, temperature, and the like as described herein.

The lighting system 10 may also optionally include ballast circuitry 20 and/or controller circuitry 22. The ballast circuitry 20 is configured to convert an AC signal (e.g., supplied by wiring in the ceiling 12) into a DC signal at a desired current and voltage to power the light engines 16(1)-(n). The controller circuitry 22 may be configured to generate one or more control signals to adjust the operation of the light engines 16(1)-(n), for example, the brightness (e.g., a dimmer circuitry) of the light engines 16(1)-(n), color of the light emitted from the light engines 16(1)-(n) (e.g., one or more of the light engines 16(1)-(n) may include two or more LEDs configured to emit light having different wavelengths, wherein the controller circuitry 22 may adjust the relative brightness of the different LEDs in order to change the mixed color from the light engines 16(1)-(n)), adjust for changes in ambient lighting conditions (e.g., an ambient light sensor), adjust for temperature changes, adjust for changes in output due to lifespan changes, and the like.

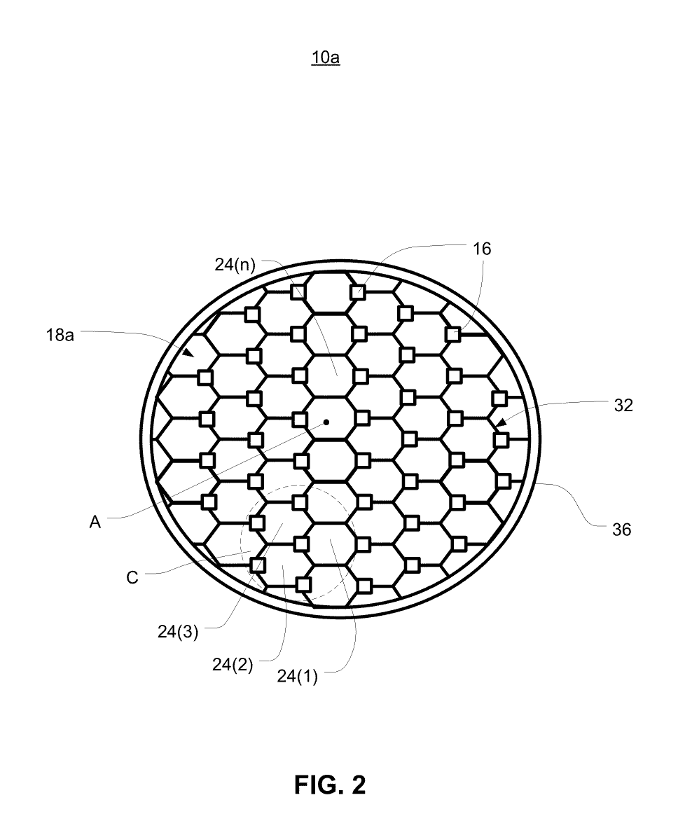

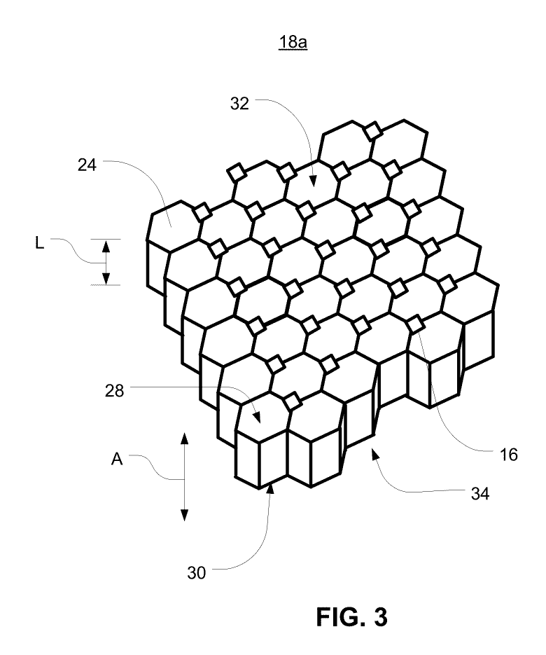

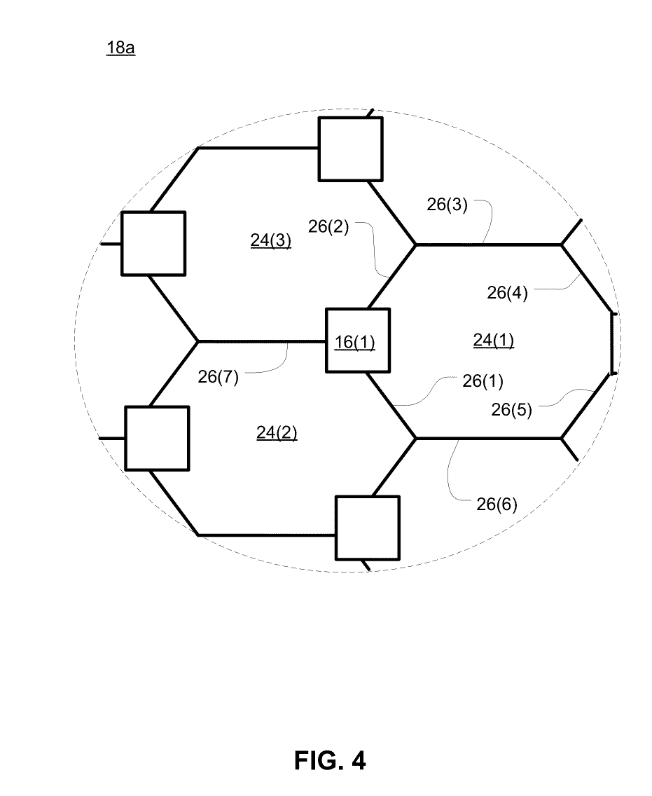

With reference to FIGS. 2-4, one embodiment of a lighting system 10a consistent with present disclosure is generally illustrated having a plurality of light engines 16 coupled to a heat sink 18a. In particular, FIG. 2 generally illustrates a bottom end view of the lighting system 10a and FIG. 3 generally illustrates a partial perspective view of the lighting system 10a illustrating in particular the structure of heat sink 18a. FIG. 4 generally illustrates a close-up of region C in FIG. 2.

The heat sink 18a includes a thermally-conductive honey-comb structure defining a plurality of individual, enclosed heat conduits 24(1)-(n) each having a hexagonal cross-section. Each of the heat conduits 24 has a length L (FIG. 3) which extends generally along (e.g., generally parallel to) a longitudinal axis A of the lighting system 10a. In particular, each heat conduit 24 includes six sidewalls 26(1)-(6) (FIG. 4) extending along the longitudinal axis A and an entrance 28 and an exit 30 at generally opposite ends of the conduit 24 (e.g., the lower face 32 and upper face 34). The six sidewalls 26(1)-(6) collectively define one heat conduit 24(1). As may be best seen in FIG. 4, two adjacent heat conduits 24(1), 24(2) may share one common sidewall 26(1).

One or more light engines 16 may be coupled to the heat sink 18a proximate to the entrance 28 of a heat conduit 24 (e.g., to the lower face 32 of the lighting system 10a). For example, the light engines 16 may be coupled to the heat sink 18a using an adhesive, welding, soldering, and/or one or more fasteners. While the lighting system 10a has been illustrated having the light engines 16 mounted to the lower face 32 of the heat sink 18a, it should be understood that one or more light engines 16 may be mounted to a sidewall 26 within a heat conduit 24. Put another way, a light engine 16 may be positioned within a heat conduit 24 at a location from the lower face 32 up towards the upper face 34.

Optionally, one or more thermal interface materials (e.g., gap pads, not shown for clarity) may be disposed between the light engines 16 and heat sink 18a to decrease the contact thermal resistance between the light engines 16 and the heat sink 18a. The thermal interface material may include outer surfaces which directly contact (e.g., abut against) a portion of the heat sink 18a and the light engines 16 (e.g., the LED). The thermal interface material may include a material having a higher thermal conductivity, k, configured to reduce the thermal resistance between the light engines 16 and the heat sink 18a. For example, the thermal interface material may have a thermal conductivity, k, of 1.0 W/(m*K) or greater, 1.3 W/(m*K) or greater, 2.5 W/(m*K) or greater, 5.0 W/(m*K) or greater, 1.3-5.0 W/(m*K), 2.5-5.0 W/(m*K), or any value or range therein. The thermal interface material may include a deformable (e.g., a resiliently deformable) material configured to reduce and/or eliminate air pockets between the light engines 16 and the heat sink 18a to reduce contact resistance. The thermal interface material may have a high conformability to reduce interface resistance

The interface material may have a thickness of from 0.010″ to 0.250″ when uncompressed. Optionally, one or more outer surfaces of the first thermal interface material may include an adhesive layer configured to secure the thermal interface material to the light engines 16 or the heat sink 18a, respectively. The adhesive may be selected to facilitate thermal energy transfer (e.g., the adhesive may have a thermal conductivity k of 1 W/(m*K) or greater.) The thermal interface material may also be electrically non-conductive (i.e., an electrical insulator) and may include a dielectric material.

Thermal energy generated by a light engine 16 may be transferred from the light engine 16 to at least a portion of one or more heat conduits 24. For example, with reference to FIG. 4, thermal energy generated by light engine 16(1) may be transferred to sidewalls 26(1), 26(2) and 26(7) of three adjacent heat conduits 24(1)-(3). As thermal energy is transferred to the heat conduits 24(1)-(3), the temperature of the air within and/or around the heat conduits 24(1)-(3) will begin to increase, causing the heated air to rise through the passageways defined by the heat conduits 24(1)-(3) due to natural convection. Cooler ambient air (i.e., air below the lighting system 10a) will then flow into the entrances 28 of each heat conduit 24(1)-(3), through the heat conduits 24(1)-(3), and out the exit 30 above the lighting system 10a.

Heat sink 18a is therefore configured to generate a flow of air not only around the perimeter region of the heat sink 18a, but also through the lighting system 10a (e.g., through the middle/internal region of the lighting system 10a). As such, a heat sink 18a having a plurality of heat conduits 24(1)-(n) as described herein enables all light engines 16 to be immediately adjacent to a cooling structure (e.g., sidewalls 26), rather than being adjacent to other light engines 16. The air flow through the heat sink 18a therefore reduces and/or prevents the accumulation of thermal energy (e.g., heat), particularly for light engines 16 in the middle/internal region of the lighting system 10a. A lighting system 10a consistent with the present disclosure may therefore increase the capacity of light engines 16 (e.g., the number of light engines 16 and/or luminous power (i.e., luminous flux) of the light engines 16) while preventing overheating and may also enable more light engines 16 to operate within an optimal temperature range of the light engines 16.

The heat sink 18a may be made from a material with a high thermal conductivity such as, but not limited to, a material having a thermal conductivity of 100 W/(m*K) or greater, for example, 200 W/(m*K) or greater. According to one embodiment, the heat sink 18a may include a metal or metal alloys (such as, but not limited to, aluminum, copper, silver, gold, or the like), plastics (e.g., but not limited to, doped plastics), as well as composites. The length and width of the heat conduits 24 (e.g., the total surface area of the heat conduits 24) may depend upon a number of variables including, but not limited to, the maximum power rating of the light engines 16, the desired steady-state junction temperature of the light engines 16, the desired overall size/shape of the lighting system 10a and/or overall weight of the lighting system 10a. The heat sink 18a may also optionally include reflective surfaces. For example, the heat conduits 24 may be polished and/or include an optically reflective material to increase the optical performance of the lighting system 10a.

According to one embodiment, the light engines 16 may include a collection of LED packages such as the OSLON® LUW CP7P, available from Osram Opto Semiconductors GmbH. The heat sink 18a may also include a honeycomb structure such as Plascore™ PCGA-XR1 aluminum 3003 having a hexagonal cell size of ¾ inch to one inch, and a cell height of one inch. The lighting system 10a may have an overall diameter of 16 inches. It should be appreciated, however, that this is only for illustrative purposes, and is not a limitation of the present disclosure unless specifically claimed as such.

Additionally, the density of the light engines 16 (i.e., the number of light engines 16 per cross-sectional area of the heat sink 18a) may be selected based on the desired luminous power (i.e., luminous flux), the amount of heat generated by the light engines, and/or the desired steady-state operating temperature. For example, while lighting system 10a is illustrated having three light engines 16 associated with each heat conduit 24, the lighting system 10a may have more or less light engines 16 associated with each heat conduit 24.

Optionally, the lighting system 10a may include one or more support frames 36 (FIG. 2). While the support frame 36 is illustrated disposed around the perimeter of the lighting system 10a, it should be understood that the support frame 36 may include additional traverse supports (not shown for clarity) which may be in addition to or replace the perimeter support frame. The support frame 36 may optionally include a reflective material and/or may be made from an optically reflective material to increase the optical performance of the lighting system 10a. For example, support frame 36 may be made as a plastic part that is, subsequent to molding, metalized so as to be reflective or coated with reflective white paint. An example of a suitable plastic is a polycarbonate marketed by Bayer MaterialScience under the trade name Makrolon 6265.

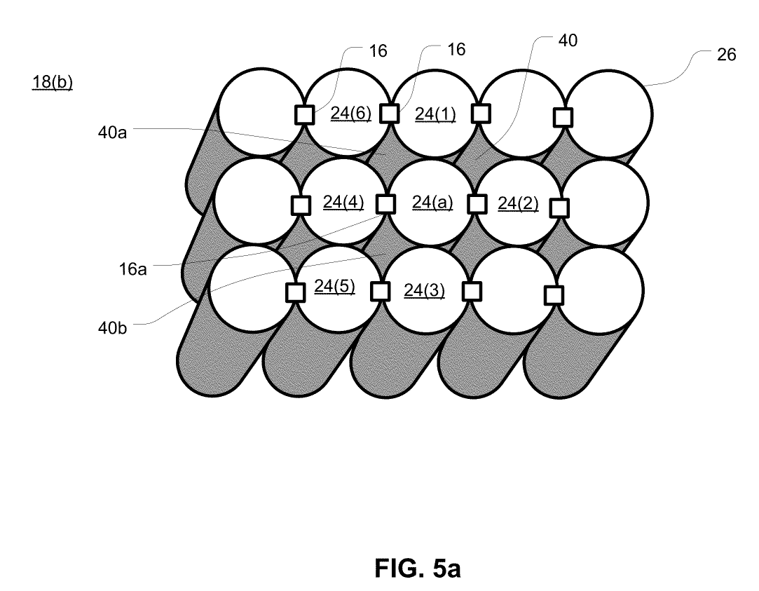

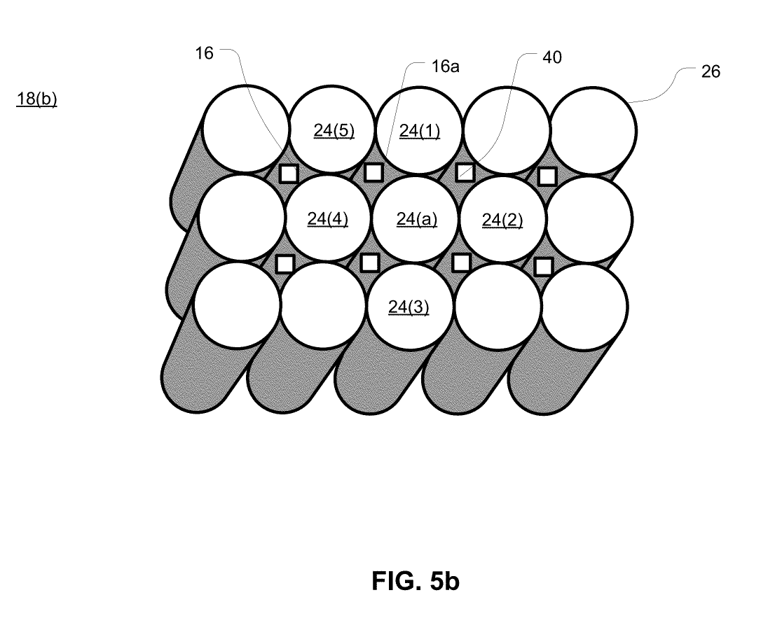

Turning now to FIGS. 5a and 5b, another embodiment of a heat sink 18b consistent with the present disclosure is generally illustrated. The heat sink 18b may include a plurality of generally cylindrical heat conduits 24(1)-(n), each defined by a single sidewall 26. One or more cylindrical heat conduits 24 may be arranged such that each cylindrical heat conduit 24(a) abuts four adjacent cylindrical heat conduits 24(1)-(4) as generally illustrated. The regions 40 between two adjacent cylindrical heat conduits 24 may be either solid (i.e., the material of the heat sink 18b) and/or may be hollow (i.e., define an additional heat conduit through which air may flow through the heat sink 18b).

According to one embodiment, one or more light engines 16 may be coupled to the heat conduits 24 such that each light engine 16 is associated with (i.e., transfer thermal energy) two heat conduits (e.g., light engine 16a is associated with heat conduits 24(a) and 24(4)) as generally illustrated in FIG. 5a when the regions 40 are hollow. When the regions 40 are solid, light engine 16a may transfer thermal energy to two heat conduits (24(a) and 24(4)) as well as two solid regions 40(a) and 40(b), which may each transfer thermal energy to two heat conduits (e.g., 24(3), 24(5) and 24(1) and 24(6), respectively). Alternatively (or in addition), one or more light engines 16 may be coupled to the regions 40 (e.g., when the regions 40 are solid) as generally illustrated in FIG. 5b such that each light engine 16 is associated with four heat conduits (e.g., light engine 16a is associated with heat conduits 24(1), 24(a), 24(4), and 24(5)).

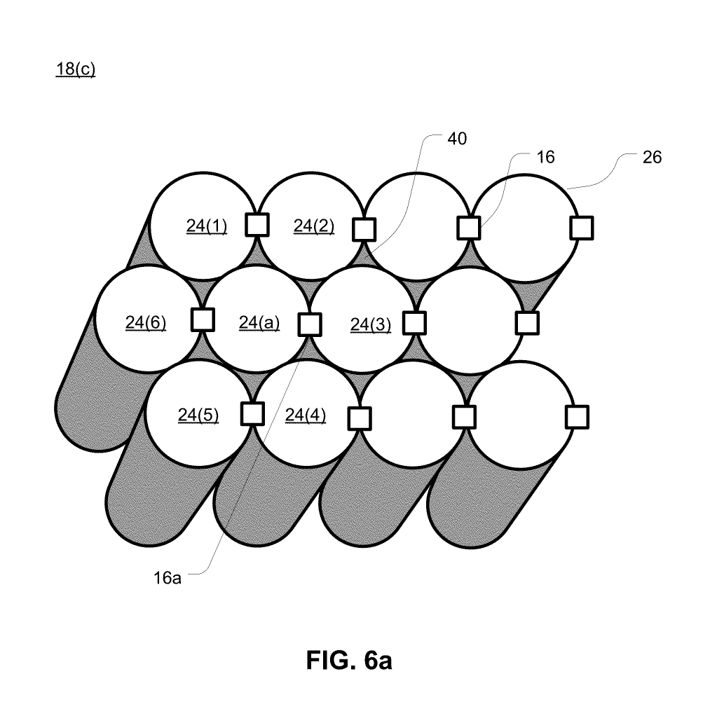

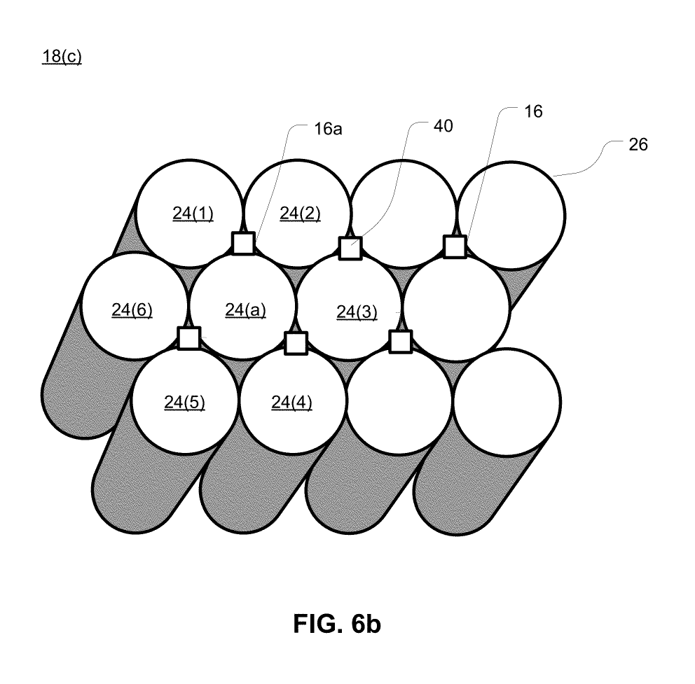

FIGS. 6a and 6b illustrate another embodiment of a heat sink 18c consistent with the present disclosure having a plurality of generally cylindrical heat conduits 24(1)-(n) similar to FIGS. 5, except that the cylindrical heat conduits 24 are arranged such that at least cylindrical heat conduit 24(a) is tangential to six adjacent cylindrical heat conduits 24(1)-(6) as generally illustrated. The regions 40 between two adjacent cylindrical heat conduits 24 may be either solid (i.e., the material of the heat sink 18b) and/or may be hollow (i.e., define an additional heat conduit through which air may flow through the heat sink 18c). As may be appreciated, the arrangement of FIGS. 6a and 6b may increase the density of the heat conduits 24, though the region 40 between the heat conduits 24 may be reduced.

According to one embodiment, one or more light engines 16 may be coupled to the heat conduits 24 such that each light engine 16 is associated with two heat conduits (e.g., light engine 16a is associated with heat conduits 24(a) and 24(3)) as generally illustrated in FIG. 6a when the regions 40 are hollow. When the regions 40 are solid, the light engines 16 may be coupled to the heat conduits 24 such that each light engine 16 is associated with four heat conduits (e.g., light engine 16a is associated with heat conduits 24(a), 24(2) , 24(3), and 24(4)) as generally illustrated in FIG. 6a. Alternatively (or in addition), one or more light engines 16 may be coupled to the regions 40 (e.g., when the regions 40 are solid) as generally illustrated in FIG. 6b such that each light engine 16 is associated with three heat conduits (e.g., light engine 16a is associated with heat conduits 24(a), 24(1), and 24(2)).

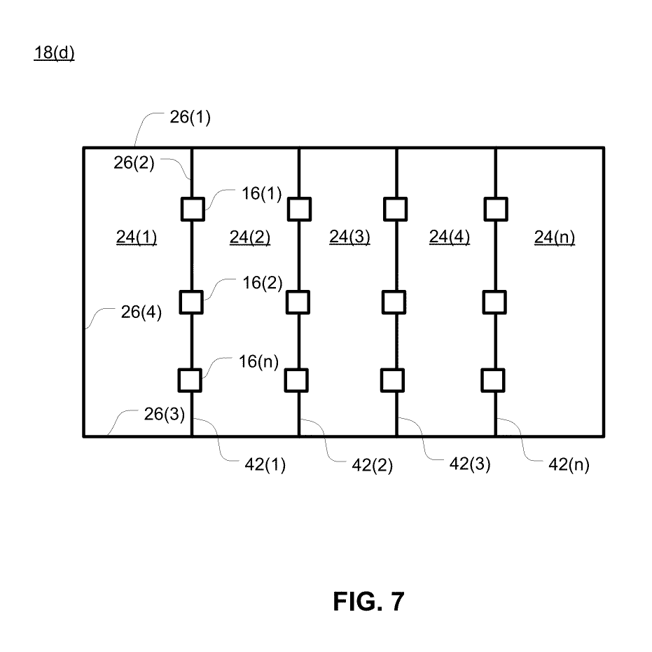

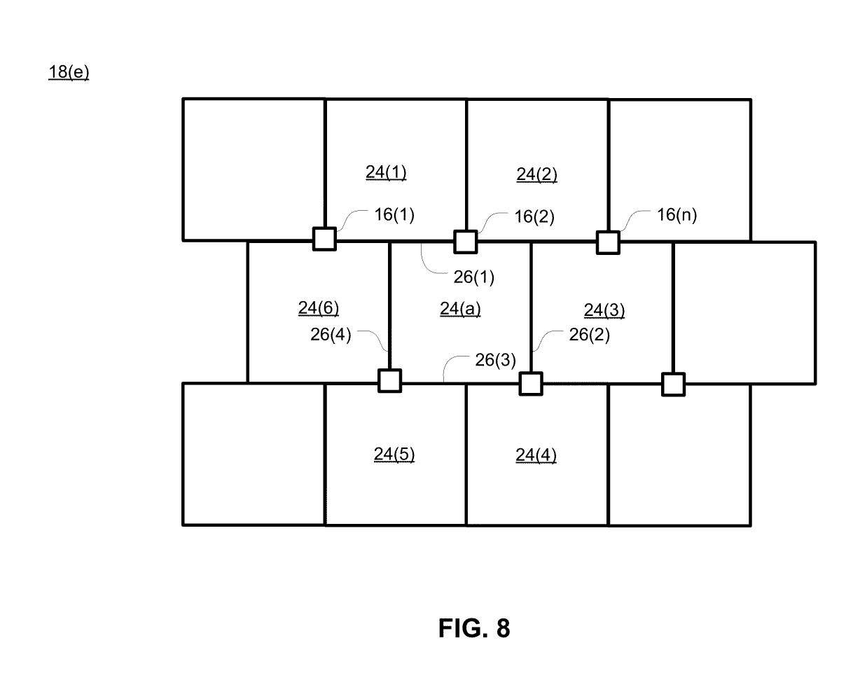

With reference to FIG. 7, yet another embodiment of a heat sink 18d consistent with the present disclosure is generally illustrated. The heat sink 18d may include a lattice-like configuration defining a plurality of generally rectangular heat conduits 24(1)-(n), each having four sidewalls 26(1)-(4). One or more of the sidewalls 26(1)-(4) may be shared with an adjacent heat conduit 24, for example, as generally illustrated. Alternatively, the heat sink 18e, FIG. 8, may include a lattice-like configuration defining a plurality of generally rectangular heat conduits 24(1)-(n) arranged such that at least rectangular heat conduit 24(a) abuts six adjacent heat conduits 24(1)-(6) as generally illustrated. In particular, one or more of the heat conduits may have two sidewalls which are each partially shared with two adjacent (i.e., abutting) heat conduits as well as two sidewalls which are shared with an adjacent (i.e., abutting) heat conduit. For example, heat conduit 24(a) may include sidewall 26(1) which is shared with heat conduits 24(1), 24(2); sidewall 26(3) which is shared with heat conduits 24(4) and 24(5); and sidewalls 26(2) and 26(4)) which are shared with heat conduits 24(3) and 24(6), respectively.

Simulations were performed on a lighting system 10a consistent with FIGS. 2-4. For experimental purposes, the operating and junction temperatures were estimated by considering that each LED of the light engine runs at nominal current of 350 mA and power of 1.1 W. Heat-transfer simulation was used to estimate heat loss by natural convection in a single hexagonal heat conduit (e.g., cell) of FIGS. 2-4 having LEDs mounted to the lower face (i.e., the bottom) of the lighting system. An LED (e.g., light engine 16(1) in FIG. 4) associated with heat conduit 24(1) transfers 2/3 of the heat generated to two sidewalls of heat conduit 24(1) (i.e., sidewalls 26(1) and 26(2)) and ⅓ of the heat generated to a common sidewall (i.e., sidewall 26(7)) of two adjacent heat conduits (i.e., heat conduits 24(2) and 24(3)).

The simulations were preformed based on a LED 16(1) releasing 0.7 W of heat (e.g., 64% of the 1.1 electrical watts supplied to it). The simulations were also performed wherein the hexagonal heat conduit 24 was approximated as a cylindrical heat conduit having a diameter of ¾ inch and a height of one inch, made of 3003 aluminum (thermal conductivity 162 W/(m-C)) and thickness 0.003 inch. 0.7 W of heat were supplied to the lower face of the heat conduit, approximating the three discrete LEDs as circumferentially-uniform heat source. The simulation was performed based on no restrictions to air flow above or below the lighting system.

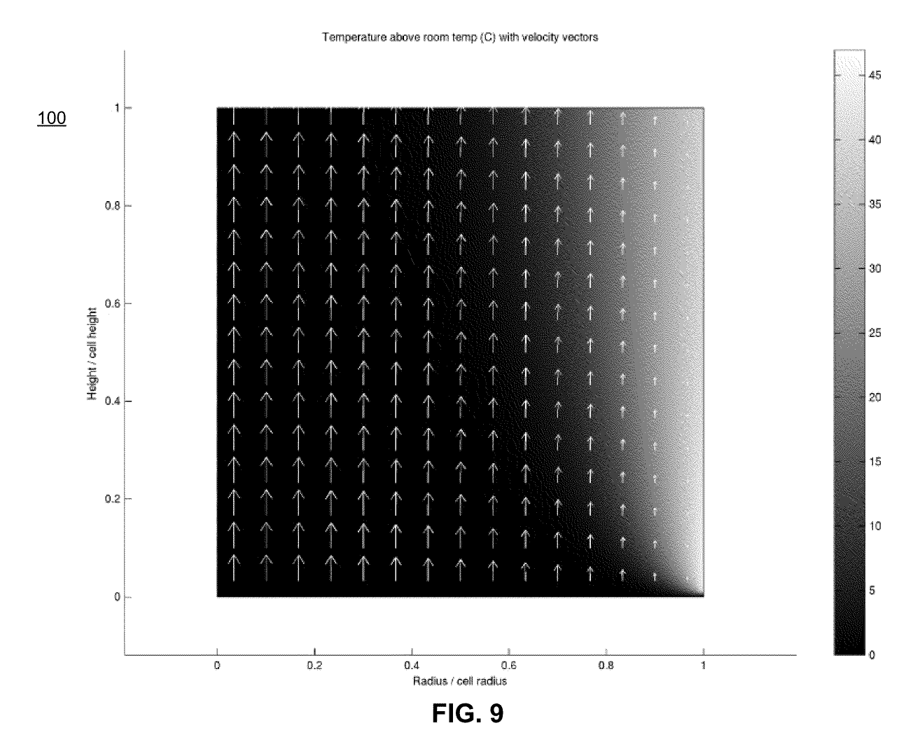

Turning now to FIG. 9, a simulated temperature map 100 of the temperature of the air (above ambient temperature) inside a heat conduit consistent with the present disclosure is generally illustrated. The vertical centerline of the heat conduit is represented at Radius=0, and the sidewall of the heat conduit is represented by the vertical line at Radius=1, with the LED heat sources represented at the lower end.

Assuming an ambient temperature of 25° C., the simulation estimates an operating temperature of approximately 75° C. Assuming that the junction temperature is 20° C. hotter, then the junction temperature is estimated to be approximately 95° C. This value is 30° C. lower than the 125° C. by the LUW CP7P data sheet. As such, it is believed that the heat system 10a consistent with at least one embodiment of the present disclosure removes a sufficient amount of heat to enable normal operation and long life.

The lighting capacity (i.e., the density of the LEDs) of the lighting system 10a of FIG. 2 may be estimated from the number of LEDs that would fit into a heat sink 18a having a disc shape with a diameter of 16 inches, wherein one LED 16 is associated with heat conduit 24. For a ¾ inch heat conduit (i.e., cell size), each heat conduit has 0.4871 square inches of cross-section. This enables approximately 400 heat conduits, and therefore 400 LEDs to fit into a 16 inch diameter disc. At just over 100 lm per LED provided by the OSLON LUW CP7P LED package, a lighting system 10a consistent with the present disclosure may provide 40,000 lumens. In addition, the lighting capacity of the lighting system 10 may be achieved with the LEDs operating at a junction temperature which is 30° C. lower than the manufacturer specified junction temperature as discussed above. The lighting capacity of the lighting system 10 is more than 3 times the lumen output of other LED high-bay lighting systems (for example, which may output 15,680 lumens). One of the reasons that lighting capacity of a lighting system 10 consistent with the present disclosure may be so high is a result of the superior heat-rejection/transfer in which air is allowed to flow through the heat sink 18, thereby providing a sufficiently direct heat path for each LED to the ambient air. The heat path is sufficiently direct to reduce and/or eliminate the effects of heat generated by adjacent LEDs.

According to one aspect, the present disclosure may feature a lighting system including a heat sink having an upper and a lower face, and a plurality of light engines. The heat sink includes a plurality of individual, enclosed heat conduits extending generally parallel to a longitudinal axis of the heat sink between the upper and the lower faces. Each heat conduit has an entrance proximate to the lower face and an exit proximate to the upper face. The light engines are each coupled to at least one heat conduit such that thermal energy generated by the light engines is transferred to the heat conduits to cause air to flow through each of the heat conduits due to convection.

The terms “first,” “second,” “third,” and the like herein do not denote any order, quantity, or importance, but rather are used to distinguish one element from another, and the terms “a” and “an” herein do not denote a limitation of quantity, but rather denote the presence of at least one of the referenced item.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A lighting system comprising:
a heat sink having an upper and a lower face, said heat sink further comprising a plurality of individual, enclosed heat conduits extending generally parallel to a longitudinal axis of said heat sink between said upper and said lower faces, each heat conduit having an entrance proximate to the lower face and an exit proximate to said upper face; and
a plurality of light engines, wherein said light engines are each coupled to at least one heat conduit such that thermal energy generated by said light engines is transferred to said heat conduits to cause air to flow through each of said heat conduits due to convection.

2. The lighting system of claim 1, wherein said heat conduits have a hexagonal cross-section having six sidewalls.

3. The lighting system of claim 2, wherein said heat conduits form a honeycomb structure.

4. The lighting system of claim 3, wherein said light engines are each coupled to a portion of three adjacent heat conduits.

5. The lighting system of claim 4, wherein said light engines transfer thermal energy to at least two sidewalls associated with a first heat conduit and at least one sidewall associated with two adjacent heat conduits.

6. The lighting system of claim 1, wherein said heat conduits have a generally circular cross-section.

7. The lighting system of claim 6, wherein a heat conduit contacts four adjacent heat conduits.

8. The lighting system of claim 7, wherein said light engines are configured to transfer thermal energy to two adjacent heat conduits.

9. The lighting system of claim 7, wherein said light engines are configured to transfer thermal energy to four adjacent heat conduits.

10. The lighting system of claim 6, wherein a heat conduit contacts six adjacent heat conduits.

11. The lighting system of claim 10, wherein said light engines are configured to transfer thermal energy to four adjacent heat conduits.

12. The lighting system of claim 10, wherein said light engines are configured to transfer thermal energy to three adjacent heat conduits.

13. The lighting system of claim 1, wherein said heat conduits have a generally rectangular cross-section.

14. The lighting system of claim 13, wherein a heat conduit contacts two adjacent heat conduits.

15. The lighting system of claim 14, wherein said light engines are configured to transfer thermal energy to two adjacent heat conduits.

16. The lighting system of claim 13, wherein a heat conduit contacts six adjacent heat conduits.

17. The lighting system of claim 16, wherein said light engines are configured to transfer thermal energy to at least three adjacent heat conduits.

18. The lighting system of claim 1, wherein said light engines include light emitting diodes (LEDs).

19. The lighting system of claim 1, wherein said light engines are coupled proximate to said lower face of said heat sink.

20. The lighting system of claim 1, wherein said light engines are coupled within a heat conduit between said lower and upper faces of said heat sink.
